(19) United States
(12) Patent Application Publication
(10) Pub. No.: US 2009/0199279 A1
(43) Pub. Date: Aug. 6, 2009

(54) METHOD FOR CONTENT LICENSE MIGRATION WITHOUT CONTENT OR LICENSE REACQUISITION

(75) Inventors: Sebastian Lange, Seattle, WA (US); Victor Tan, Kirkland, WA (US); Adam G. Poulos, Bothell, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/023,097

(22) Filed: Jan. 31, 2008

(51) Int. Cl. H04L 9/32

(52) U.S. Cl. 726/6

(57) ABSTRACT

Techniques for migrating content from a first set of conditions to a second set of conditions are disclosed herein. In particular, a content migration certificate is utilized to enable content migration and set forth under what conditions content may be accessed after migration. The content migration certificate may, for example, be stored as a file in a removable storage unit or transferred online once an indication that conditions have changed is received. The change in conditions may involve a new device attempting to access the content file, a new user attempting to access the content, or any other similar conditions. Access to the information in the content migration certificate may be protected by encryption so that only devices and/or users meeting the conditions of the certificate are permitted to transfer content. By accessing the content migration certificate in the prescribed manner, migration of content is enabled in a controlled and easy process.

### BACKGROUND

In many digital rights management (DRM) systems, purchased content is individually licensed to specific devices. For example, a customer might purchase a music track from an online service, enabling him to download a special version of the music file that contains information uniquely identifying the hardware from which the user made the purchase. Depending on severity of restrictions in the granted license, attempting to copy and play this music file on another device (e.g., the customer's friend's computer) might not work.

While these and other similar restrictions are certainly desirable for content providers and online services hoping to prevent end user piracy, the restrictions place a burden on honest users that suffer device failure or choose to replace their device with an improved model. In the worst case, content providers or online services will treat the replacement device as a completely new and different device, forcing the customer to repurchase his entire content investment. In better cases, these services may offer complicated re-licensing workarounds, where the online service's database is temporarily modified to allow the user one chance to re-download all of their content to the replacement device. However, this is expensive to the service in terms of bandwidth for transferring the content and the cost of customer service initiating this manual process. It is also potentially expensive to the customer in terms of time, as the customer could easily spend hours waiting for re-downloads to complete for content that the customer has already downloaded to the original device.

### SUMMARY

Techniques for migrating content from a first set of conditions to a second set of conditions are disclosed herein. In particular, a content migration certificate is utilized to enable content migration and set forth under what conditions content may be accessed after migration. The content migration certificate may, for example, be stored as a file in a removable storage unit or transferred online once an indication that conditions have changed is received. The change in conditions may involve a new device attempting to access the content file, a new user attempting to access the content, or any other similar conditions. Access to the information in the content migration certificate may be protected by encryption so that only devices and/or users meeting the conditions of the certificate are permitted to transfer content. By accessing the content migration certificate in the prescribed manner, migration of content is enabled in a controlled and easy process.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The illustrative embodiments will be better understood after reading the following detailed description with reference to the appended drawings, in which:

FIG. 1 is a block diagram an exemplary computing device;

FIG. 2 is a system diagram depicting the transfer of content from a first computing device to a second computing device in a first manner;

FIG. 3 is a system diagram depicting the transfer of content from a first computing device to a second computing device in a second manner;

FIG. 4 is a flow diagram depicting the steps performed for transferring content from a first computing device to a second computing device as shown in FIG. 2; and,

FIG. 5 is a flow diagram depicting the steps performed for transferring content from a first computing device to a second computing device as shown in FIG. 3.

### DETAILED DESCRIPTION

The inventive subject matter is described with specificity to meet statutory requirements. However, the description itself is not intended to limit the scope of this patent. Rather, it is contemplated that the claimed subject matter might also be embodied in other ways, to include different steps or combinations of steps similar to the ones described in this document, in conjunction with other present or future technologies

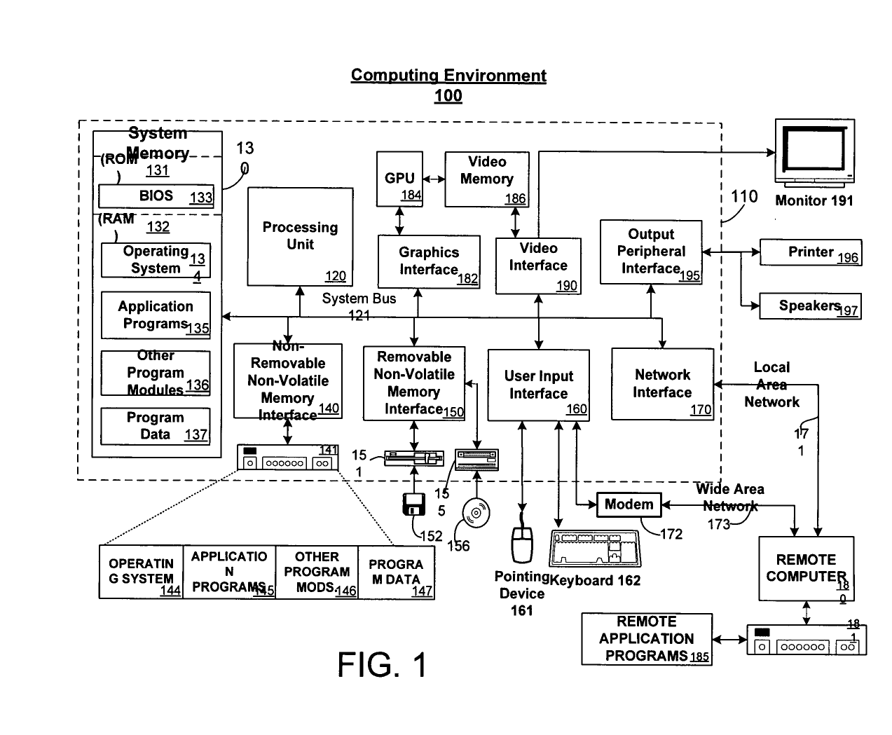

FIG. 1 illustrates an example of a suitable computing system environment 100 in which the subject matter described above may be implemented. The computing system environment 100 is only one example of a suitable computing environment and is not intended to suggest any limitation as to the scope of use or functionality of the subject matter described above. Neither should the computing environment 100 be interpreted as having any dependency or requirement relating to any one or combination of components illustrated in the exemplary operating environment 100.

With reference to FIG. 1, computing system environment 100 includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embody computer readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-RW, DVD-RW or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136 and program data 137. Operating system 144, application programs 145, other program modules 146 and program data 147 are given different numbers here to illustrate that, at a minimum, they are different copies. A user may enter commands and information into the computer 110 through input devices such as a keyboard 162 and pointing device 161, such as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A graphics interface 182 may also be connected to the system bus 121. One or more graphics processing units (GPUs) 184 may communicate with graphics interface 182. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

In order to assist in the transfer of content (e.g., music, videos, games, etc.) purchased and/or downloaded by a first computing device (e.g., computer, video game player, MP3 player, cell phone, etc) to a second computing device, the present invention involves the implementation of a content migration certificate. It will be understood that such content migration certificate, which typically will be issued by the owner or a distributor of the content, essentially enables the content to be transferred in a manner which protects the rights of all parties. Of course, any limitations or conditions placed on the content migration certificate, such as the number of available transfers, special verification requirements, or connection requirements, may be included consistent with the business policies and practices of the content owner or distributor.

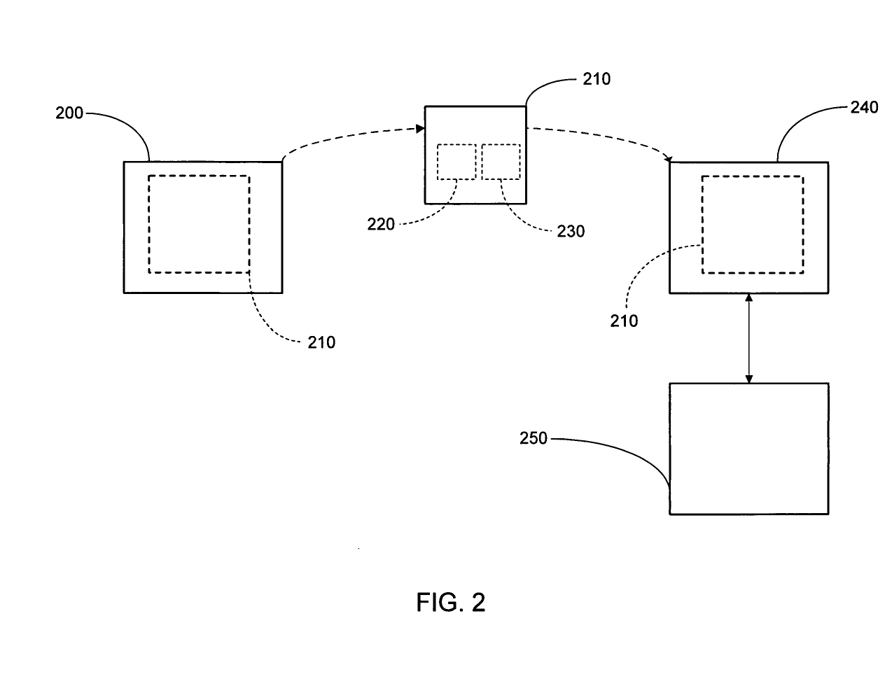

As seen in one exemplary transfer depicted in FIG. 2, otherwise known herein as an off-line transfer, it will be seen that a first computing device 200 includes a removable storage unit 210 that contains certain content therein represented by a file 220. In addition, a file 230 containing a content migration certificate is preferably stored within storage unit 210. In this case, storage unit 210 is able to be inserted into a second computing device 240, where it is desired that the content within file 220 may be usable therewith.

File 230 containing the content migration certificate will preferably include an identifier associated with first computing device 200, such as a unique ID (e.g., a serial number, user ID or the like), an identifier associated with at least one item in content file 220, and an identifier associated with second computing device 240. Once storage unit 210 is inserted into second computing device 240, it is preferred that some indication of its transfer from first computing device 200 be provided. Thereafter, the content migration certificate in file 230 is accessed via any desirable manner and the transfer of content from file 220 to second computing device 240 is enabled.

It will be appreciated that the content migration certificate may, for example, be accessed by means of a code provided at the time of content purchase or later when second computing device 240 attempts to access such content. Alternatively, second computing device 240 may be required to connect to an online service over the Internet, as represented by a server 250 having a connection with second computing device 240, whenever the content migration certificate is consulted. The certificate may include a cryptographic signature originating from a well-secured trustworthy source (e.g. device manufacturer or service provider). Signing the migration certificate blocks malicious users from tampering with it. The signing key used to sign the migration certificates may be the same key used to sign the original content licenses.

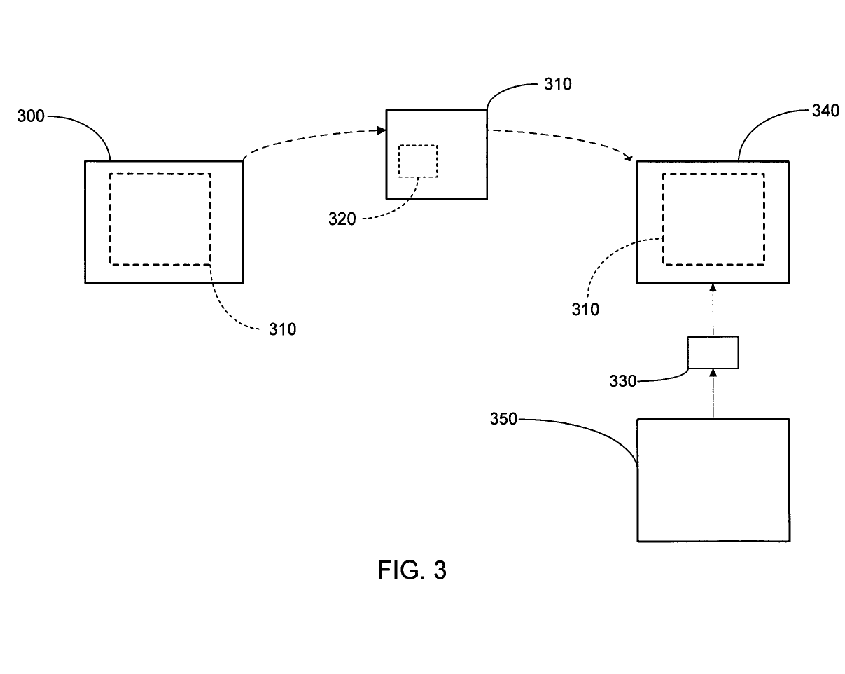

In a second type of content transfer depicted in FIG. 3, known herein as an online type, the content migration certificate is not initially contained within a storage unit 310 of a first computing device 300. Instead, once storage unit 310 including a content file 320 has been inserted into a second computing device 340, an indication is made from second computing device 340 to a server 350 that conditions have changed for the device holding the content. Once server 350 verifies that the content is eligible for a content migration certificate, it generates the content migration certificate and transfers a file 330 containing it to second computing device 340. Although file 330 is preferably encrypted prior to transfer, second computing device 340 is able to access the content migration certificate. In this way, transfer of the content to second computing device 340 is authorized. As should be appreciated, in either of the exemplary schemes depicted in FIG. 2 or 3 or any other suitable scheme, content need not necessarily be transferred from the first computer to the second computer via a removable storage device. Rather any other content transfer method (e.g., via a network) may be employed.

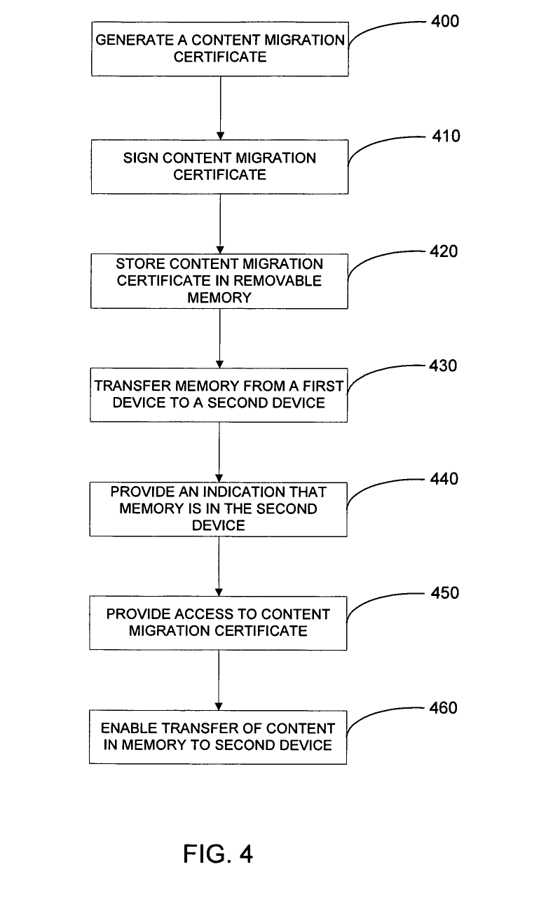

FIG. 4 is a flow chart depicting the steps undertaken in the process to transfer content from first computing device 200 to second computing device 240 as shown in FIG. 2. As seen therein, a file 230 containing a content migration certificate is generated which sets forth the authority for transferring content and the conditions under which such authority is provided (box 400). The content migration certificate may be signed (box 410) to block malicious users from tampering with it. Thereafter, file 230 is then stored in removable storage unit 210 (box 420). Once removable storage unit 210 is transferred from first computing device 200 to second computing device 240 (box 430), an indication is provided that conditions have changed (box 440). This indication may be self contained within storage unit 210 or involve signaling a remote server 250. In either event, access is provided to the content migration certificate within file 230 (box 450) under prescribed conditions or requirements. In this way, transfer of content in removable storage unit 210 to second computing device 240 is enabled (box 460).

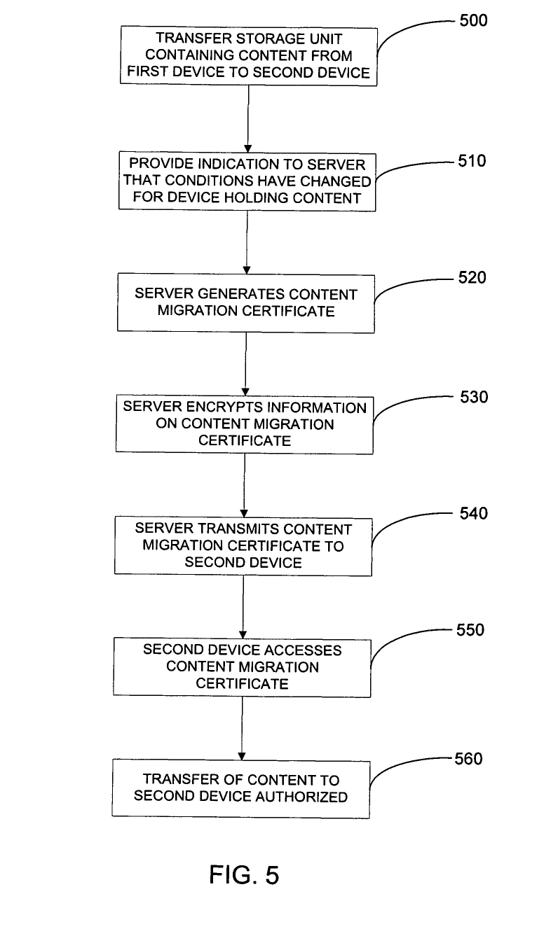

Similarly, FIG. 5 is a flow chart depicting the steps undertaken in the process to transfer content from first computing device 300 to second computing device 340 as shown in FIG. 3. As seen therein, a removable storage unit 310 containing a content file 320 is transferred from first computing device 300 to second computing device 340 (box 500). Accordingly, an indication is received by a server 350 via a connection with second computing device 340 which signifies a change from a first set of conditions to a second set of conditions (box 510). Provided content file 320 and/or second computing device 340 qualify, server 350 preferably generates a file 330 containing a content migration certificate which sets forth the authority and conditions for content transfer (box 520). It is also preferred that server 350 encrypt the information on the content migration certificate (box 530) with information unique to an issuer of the certificate. The content migration certificate is then transmitted by the issuer to second computing device 340 (box 540) so that the content may be utilized therewith. Alternatively, server 350 may issue the content migration certificate to a location external to second computing device 340 for storage. Of course, second computing device 340 would need to access the content migration certificate stored at the external location in order to access the content. After second computing device 340 is able to access the content migration certificate within file 330 (box 550), then transfer of the content within file 320 to second computing device 340 is authorized (box 560).

It is contemplated that the content migration certificate may not only permit transfer of content between computing devices, but also between users as well. In this regard, it will be appreciated that this constitutes the change in conditions and that a second user is then able to access content for which a first user was authorized. Additionally, the content migration certificate may also permit transfer of content under any other suitable change of conditions.

Another aspect of the techniques described herein for transferring content from one set of conditions to another involves an external server as part of the process. In such case, the server may determine that conditions according to which content is accessed have changed from a first set of conditions to a second set of conditions. A content migration certificate may then be requested for migrating a right to access the content from the first set of conditions to the second set of conditions. Accordingly, the content migration certificate enables the content to be accessed in accordance with the second set of conditions.

Although the subject matter has been described in language specific to the structural features and/or methodological acts, it is to be understood that the subject matter defined in the appended claims is not necessarily limited to the specific features or acts described above. Rather, the specific features or acts described above are disclosed as example forms of implementing the claims.

What is claimed:

1. A computer-readable medium having stored thereon computer-executable instructions for performing a process comprising:
receiving an indication that conditions according to which content is accessed have changed from a first set of conditions to a second set of conditions; and
generating a content migration certificate for migrating a right to access the content from a first set of conditions to a second set of conditions,
whereby the content migration certificate enables the content to be accessed in accordance with the second set of conditions.

2. The computer readable medium of claim 1, wherein the first set of conditions comprises a first computing device that is authorized to play the content and the second set of conditions comprises a second computing device that is authorized to play the content.

3. The computer readable medium of claim 2, wherein the content migration certificate comprises an identifier of the first computing device, an identifier of the second computing device, and an identifier of at least one content item to be covered by the content migration certificate.

4. The computer readable medium of claim 1, wherein the content migration certificate is signed using encryption information unique to an issuer of the content migration certificate.

5. The computer readable medium of claim 1, wherein the process further comprises transmitting the content migration certificate from an issuer of the content migration certificate to a playing computing device on which the content is to be played.

6. The computer readable medium of claim 1, wherein the content migration certificate is stored at a location external to a playing computing device on which the content is to be played.

7. The computer readable medium of claim 6, wherein the playing computing device accesses the content migration certificate stored at the external location in order to gain authority to access the content according to the second set of conditions.

8. The computer readable medium of claim 1, wherein the first set of conditions comprises a first user that is authorized to access the content and the second set of conditions comprises a second user that is authorized to access the content.

9. A computer-readable medium having stored thereon computer-executable instructions for performing a process comprising:
determining that conditions according to which content is accessed have changed from a first set of conditions to a second set of conditions; and
requesting a content migration certificate for migrating a right to access the content from a first set of conditions to a second set of conditions,
whereby the content migration certificate enables the content to be accessed in accordance with the second set of conditions.

10. The computer readable medium of claim 9, wherein the first set of conditions comprises a first computing device that is authorized to play the content and the second set of conditions comprises a second computing device that is authorized to play the content.

11. The computer readable medium of claim 10, wherein the content migration certificate comprises an identifier of the first computing device, an identifier of the second computing device, and an identifier of at least one content item to be covered by the content migration certificate.

12. The computer readable medium of claim 9, wherein the content migration certificate is signed using encryption information unique to an issuer of the content migration certificate.

13. The computer readable medium of claim 9, wherein the process further comprises receiving the content migration certificate by a playing computing device on which the content is to be played.

14. The computer readable medium of claim 9, wherein the content migration certificate is stored at a location external to a playing computing device on which the content is to be played.

15. The computer readable medium of claim 14, wherein the playing computing device accesses the content migration certificate stored at the external location in order to gain authority to access the content according to the second set of conditions.

16. The computer readable medium of claim 9, wherein the first set of conditions comprises a first user that is authorized to access the content and the second set of conditions comprises a second user that is authorized to access the content.

17. A computer-readable medium having stored thereon computer-executable instructions for enabling content to be transferred between computing devices, comprising the following steps:
generating a content migration certificate for migrating a right to access the content from a first computing device to a second computing device;
setting forth in said content migration certificate an identifier associated with the first computing device and an identifier associated with the content;
signing the content migration certificate using encryption information unique to an issuer of the content migration certificate; and,
storing the content migration certificate within a file containing the content.

18. The computer readable medium of claim 17, wherein the process further comprises transmitting the content migration certificate from an external location to the second computing device.

19. The computer readable medium of claim 17, wherein the process further comprises including an identifier associated with the second computing device to the content migration certificate.

20. The computer-readable medium of claim 17, wherein access to the content migration certificate in the second computing device enables content to be transferred thereto.
